(19) United States
(12) Patent Application Publication
(10) Pub. No.: US 2018/0375117 A1
(43) Pub. Date: Dec. 27, 2018

(54) METHOD FOR PRODUCING A FUEL CELL WITH A SCREEN-PRINTED SEAL

(71) Applicants: COMPAGNIE GENERALE DES ETABLISSEMENTS MICHELIN, Clermont-Ferrand (FR); MICHELIN RE-CHERCHE ET TECHNIQUE S.A., Granges-Paccot (CH)

(72) Inventor: Arnaud GRANDJEAN, Clermont-Ferrand (FR)

(21) Appl. No.: 15/779,994

(22) PCT Filed: Dec. 14, 2016
(86) PCT No.: PCT/FR2016/053424

§ 371 Date: May 30, 2018

(30) Foreign Application Priority Data
Dec. 16, 2015 (FR) 1562439

(51) Int. Cl. H01M 8/0273; H01M 8/241; H01M 8/0258; H01M 8/2457

(52) U.S. Cl. CPC H01M 8/0273; H01M 8/2457; H01M 8/0258; H01M 8/241

(57) ABSTRACT

A method is provided for producing a fuel cell that includes a stack of unit cells separated by bipolar plates. Each unit cell includes at least an anode element, a cathode element, an ion-exchange membrane, a reinforcing element, and a gas diffusion layer. The anode element and the cathode element are separated by the ion-exchange membrane. The method includes steps of: producing a silicone seal by screen printing, positioning the silicone seal on the reinforcing element, assembling constituent elements of a unit cell, and positioning a bipolar plate on each side of the unit cell. The steps of the method are repeated as many times as needed depending on a desired size of the stack.

### FIELD OF THE INVENTION

The present invention relates to the field of fuel cells, and more particularly the field of producing and assembling fuel cells.

A fuel cell allows the generation of electrical energy via an electrochemical reaction using a fuel, generally hydrogen, and an oxidizer, generally oxygen.

A solid electrolyte proton exchange membrane-type fuel cell (PEMFC) usually comprises a stack of unit cells, in the form of plates, making up electrochemical generators, each of the unit cells being separated from the adjacent unit cells by bipolar plates. Each unit cell comprises an anode element and a cathode element, which are separated by a solid electrolyte in the form of an ion-exchange membrane, made, for example, from a sulphur-containing perfluorinated polymer material. This entity comprising the cathode element, the anode element and the solid electrolyte forms a membrane-electrode assembly, also called an MEA.

Furthermore, these assemblies are regularly supplemented by adding reinforcers, as described in the document US2008/0105354, which are formed from polymer films, and which make it possible to avoid the deterioration of the MEAs by facilitating the handling of the assemblies, or by limiting the dimensional variations of the membrane as a function of temperature and humidity. These reinforcers are generally superposed at the periphery of the electrodes. In addition, gas diffusion layers are inserted between the electrodes and the bipolar plates.

According to a usual alternative embodiment, each bipolar plate supplies, on one side, fuel to the unit cell adjacent to that side and, on the other side, supplies oxidizer to the unit cell adjacent to this other side, the supplying operations by the bipolar plates occurring in parallel. Gas diffusion layers, for example made of carbon cloth, are installed on either side of the MEAs in order to provide the electrical conduction and the homogeneous arrival of the reactive gases provided via the bipolar plates.

The successive stacking of the bipolar plates, of the gas diffusion layers and of the MEAs is held under bearing pressures that must ensure good electrical contact and good airtightness. However, holding under pressure is not sufficient to ensure perfect airtightness. It proves to be useful to have, between the electrode-membrane assembly and the bipolar plate, a seal, made for example from silicone or from EPDM.

Several methods are known for producing such a seal, for example moulding or cutting. However, these methods have various disadvantages. Thus, production via cutting leads to a high material waste level, and poses a technical difficulty for set-up. Production via moulding is complex to set up, and requires the use of expensive tooling. Furthermore, production via moulding does not allow a seal to be deposited directly on a reinforcer.

The aim of the present invention is therefore to propose a method for producing a fuel cell making it possible to overcome this disadvantage.

### BRIEF DESCRIPTION OF THE INVENTION

Thus, the invention relates to a method for producing a fuel cell comprising a stack of unit cells separated by bipolar plates, the method comprising the following steps, each unit cell comprising at least an anode element and a cathode element which are separated by an ion-exchange membrane, a reinforcing element and a gas diffusion layer, the method comprising the following steps:
a step of producing a silicone seal by screen printing,
a step of positioning the silicone seal on the reinforcing element,
a step of assembling the constituent elements of a unit cell, and
a step of positioning a bipolar plate on either side of the unit cell, these steps being repeated as many times as needed depending on the size of the desired stack.

Thus, in a method according to the invention, the screen-printed seal is deposited on the reinforcer before the membrane-electrode assembly is made. Indeed, it has been found that, if all of the constituent elements of a unit cell are assembled beforehand, the gas diffusion layer is higher than the reinforcer, and this thickness created in this manner hinders screen printing and thus degrades the quality of the deposited seal. Furthermore, making a seal by screen printing, which will be detailed later, requires the use of solvents, which can pollute the membrane during deposition. Finally, since the deposition by screen printing is not infallible, it is preferable, in the event of a defective seal, to be able to replace only the reinforcing element, without having to replace all the constituent elements of the assembly.

The use of screen printing for producing seals has many advantages including:
minimal use of product,
the possibility of rapid adjustment of the pattern or of the thickness,
low set-up and material costs,
good repeatability,
an almost-constant seal thickness,
the possibility of performing mass-removal on rollers.

In a particular embodiment, the step of producing a silicone seal by screen printing comprises the following steps:
a screen, also called a frame, is produced, which makes it possible to display the desired seal pattern,
a quantity of silicone that is dependent upon the size of the frame is deposited on the frame,
a scraper-type object is passed over the frame, which makes it possible to deform the frame and to pass the silicone through at the provided locations of the pattern,
the frame is then removed, and the seal is passed into an oven to allow the polymerization thereof.

In another aspect of the invention, it is possible to use a silicone that polymerizes during exposure to ultraviolet radiation. However, such a silicone is more expensive and more fragile, and therefore does not represent a preferred solution.

In a particular embodiment, the screen is made from a PET fabric, forming a canvas, the pores of which are blocked, except those making it possible to form the desired pattern.

In this embodiment, the silicone seal is deposited through meshes of a canvas, thereby creating micro-roughness. In order to prevent this micro-roughness from decreasing the airtightness of the seal, it is necessary for it to be filled in during the production of the seal. Thus, in an advantageous embodiment, the method for producing the seal comprises, before the step of passing the seal into an oven, a step of resting the seal allowing the micro-roughness to fill itself in. This is made possible by virtue of the properties of the silicone. The necessary rest time is generally approximately one to two minutes.

Preferably, the silicones used are of the RTV2 type (where RTV means “Room Temperature Vulcanisation”). The silicone mixture is composed of at least one polyorganosiloxane having, per molecule, at least two vinyl groups and of at least one polyorganosiloxane having, per molecule, at least two silicon-bonded hydrogen atoms (SiH) and a catalyst, preferably composed of at least one metal belonging to the platinum group.

Another aspect of the invention relates to a fuel cell unit cell, comprising
an ion-exchange membrane,
two electrodes arranged on either side of the membrane,
a first reinforcer installed on the membrane,
   the cell being characterized in that a screen-printed seal is deposited on the reinforcer.

Another aspect of the invention further relates to a fuel cell made up of a stack of unit cells according to the invention, between which are inserted bipolar plates allowing the supply of fuel gas and oxidizing gas to the fuel cell.

### BRIEF DESCRIPTION OF THE FIGURES

Other aims and advantages of the invention will appear more clearly in the following description of a preferred but non-limiting embodiment, illustrated by the following figures in which:

FIG. 1 shows an example of a bipolar plate for a fuel cell having a groove intended to allow the presence of a screen-printed seal,

FIG. 2 shows a screen for screen printing,

FIG. 3 shows a side view of a scraper used in the context of producing a seal by screen printing,

FIGS. 4 and 5 show two configurations.

### DESCRIPTION OF THE PREFERRED EMBODIMENT OF THE INVENTION

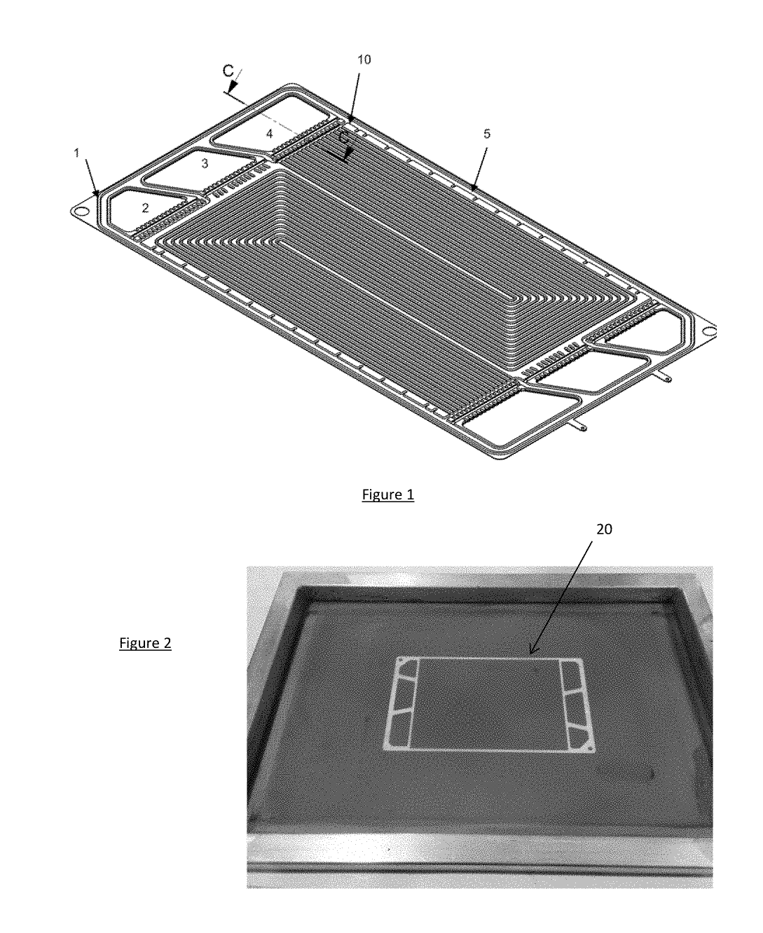

A bipolar plate as shown in FIG. 1 comprises a central skeleton 11 made up of two thin plates, which are parallel and rigidly connected by a method such as gluing, welding or brazing. One face of this plate is intended to be placed against an anode, in a fuel cell, and the other face is intended to be placed against a cathode. The thin plates have several holes made at the periphery thereof, in order to form collectors of fuel 2, oxidizer 3, and cooling liquid 4. The plates also include a set of channels 5, which are placed in the thickness thereof, in order to allow the flow, at the surface, of fuel or of oxidizer. Furthermore, the thin plates include openings for connecting a collector to a gas flow channel.

The seal produced by screen printing is intended to be affixed to the location 10 indicated in this FIG. 1. This seal must therefore have a pattern 20 of the type of that appearing on the screen shown in FIG. 2. It is specified in this case that there are several types of bipolar plates, each having different patterns. Thus, the pattern shown in FIG. 2 does not correspond to the bipolar plate of FIG. 1. Two different patterns are intentionally shown, which are covered by the present invention, the use of which is not limited to a particular type of bipolar plate.

This screen, also called a frame, is formed from a PET fabric, the meshes and the thread diameter of which can be adapted to the various uses. The fabric is then coated with a photosensitive product known as an emulsion on which a template corresponding to the pattern to be produced is deposited. After exposure to a UV lamp, the photosensitive product hardens except for the area masked by the template. The excess is then cleaned off. Thus, all pores of the canvas, except for the area of the pattern, are blocked in order to allow the product to pass only in the desired areas.

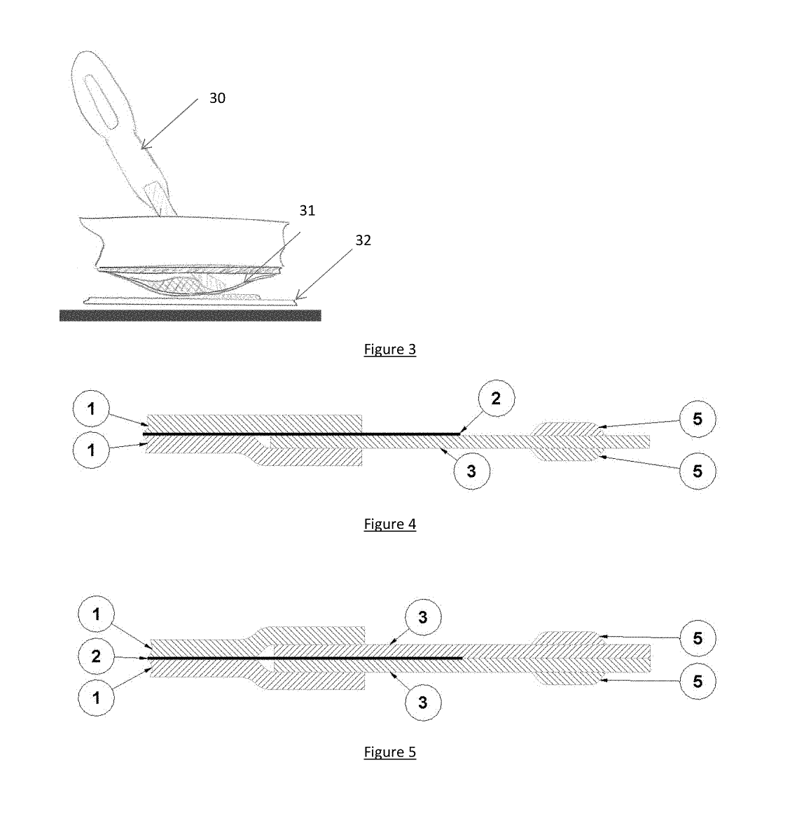

Once this frame, or screen, has been produced, it is then possible to produce a seal, using a method as shown in FIG. 3.

Firstly, the frame is arranged on the support on which the seal will be deposited. The frame is installed slightly above the support so as to avoid contact therebetween before the scraper passes over. The product to be deposited, for example silicone, is poured in bulk into the frame.

The product is then spread out evenly over the pattern but without pressing too hard to prevent it from passing through the canvas. This operation is referred to as “coating”.

Then, a scraper 30 formed from a polyurethane or metal section, the hardness and stiffness of which can be adjusted, is passed along the entire section with a variable angle close to 45°.

The scraper will then force the canvas 31 to deform, bringing it into contact with the support 32. The silicone is then forced, upon the passage of the scraper, to pass through the canvas in order to be deposited on the support. The scraper also makes it possible to scrape the excess silicone from the surface of the screen, the latter being subsequently close for a second removal.

It is important to note that the thickness of the seal that is intended to be obtained is dependent on many factors, even though the contour is simply defined by the screen.

The parameters having an influence on the thickness of the seal are classified in descending order. These parameters can be modified prior to the implementation of the screen-printing production method, depending on the characteristics of the desired seal. Thus, specified hereafter are examples of values for these various parameters during the implementation of an example of the invention:
the type of canvas: for example, a canvas of 27-140 type is used, i.e. 27 threads per centimetre, and threads having a diameter of 140 micrometres,
the viscosity of the silicone, for example 60000 pascal seconds,
the angle of the scraper, preferably between 30° and 50°,
the pressure applied to the scraper, for example 4 kilograms per 100 millimetres of scraper,
the Shore hardness of the scraper, preferably between 60 and 80 Shore,
the height outside the frame, which is preferably determined depending on the size of the frame, for example height=width of the screen*0.006,
the travelling speed of the scraper, for example 50 millimetres per second.

Once the seal has been deposited, it is necessary for it to harden in order to obtain the characteristics that make it possible to produce airtightness. Firstly, the deposited seal is left to rest for approximately 1-2 minutes, the time taken for the micro-roughness due to passage through the canvas to fill itself in. The seal is then passed into an oven to be set to a temperature between 80° C. and 130° C. If the oven is set to 130° C., the polymerization time will be approximately 10 minutes. The use of low temperature, of approximately 80° C., avoids degrading the element on which the seal is deposited.

Preferably, as mentioned above, an RTV2-type silicone will be used. This silicone has a long pot-life of approximately 15 h, making it possible to perform screen printing without the silicone hardening prior to shaping.

After producing the seal, it is possible to move on to the step of assembling the unit cell, and then the fuel cell. As previously indicated, the seal is used to produce the airtightness between a unit cell and the following bipolar plate in the stack.

Two different configurations of a unit cell are shown in FIGS. 4 and 5. These figures represent a sectional view of a part of a stack.

In FIG. 4, the membrane 2 is glued or welded on a reinforcer 3.
The lower gas diffusion layer 1 is installed astride the membrane 2 and the reinforcer 3 on which two screen-printed seals 5 have been previously deposited on both sides.
The upper gas diffusion layer 1′ is only installed on the membrane 2.
In FIG. 4, it is noted that the membrane 2 projects from the gas diffusion layers. It is, however, possible for the membrane to stop in line with these layers.

In the configuration shown in FIG. 5, the membrane 2 is installed between two reinforcers 3, the latter are glued or welded together and on the membrane.
Each of the gas diffusion layers 1 is installed astride the membrane 2 and a reinforcer 3, respectively.
In this configuration, the screen-printed seals 5 are installed on each of the reinforcers, respectively.

1-6. (canceled)

7: A method for producing a fuel cell that includes a stack of unit cells separated by bipolar plates, in which each unit cell includes at least an anode element, a cathode element, an ion-exchange membrane separating the anode element from the cathode element, a reinforcing element, and a gas diffusion layer, the method comprising steps of:
(a) producing a silicone seal by screen printing;
(b) positioning the silicone seal on a reinforcing element;
(c) assembling constituent elements of a unit cell, the unit cell having first and second sides;
(d) positioning a bipolar plate on each of the first and second sides of the unit cell; and
(e) repeated the steps (a) through (d) as many times as needed to obtain a desired stack size.

8: The method according to claim 7, wherein the step (a) includes:
producing a screen or frame that displays a desired seal pattern,
depositing a quantity of silicone on the screen or frame, the quantity being dependent upon a size of the screen or frame,
passing a scraper over the screen or frame to deform the screen or frame and to pass the silicone through locations of the screen or frame corresponding to the desired seal pattern, to produce an unpolymerized seal,
removing the screen or frame from the unpolymerized seal, and
inserting the unpolymerized seal into an oven to allow polymerization to occur to produce the silicone seal.

9: The method according to claim 8, wherein the screen or frame is a canvas made from a PET fabric.

10: The method according to claim 9, wherein the step (a) further includes, before inserting the unpolymerized seal into the oven, resting the unpolymerized seal to allow micro-roughness to even out.

11: A unit cell of a fuel cell, the unit cell comprising:
an ion-exchange membrane;
two electrodes arranged on opposite sides of the membrane, such that the membrane separates the two electrodes;
a reinforcer installed on the membrane; and
a screen-printed seal deposited on the reinforcer.

12: A fuel cell comprising:
at least one unit cell, each unit cell including:
an ion-exchange membrane,
two electrodes arranged on opposite sides of the membrane, such that the membrane separates the two electrodes,
a reinforcer installed on the membrane, and
a screen-printed seal deposited on the reinforcer; and
a bipolar plate positioned on each of two sides of the unit cell, each bipolar plate being structured to enable fuel gas and oxidizing gas to flow.
